(19) United States
(12) Patent Application Publication
(10) Pub. No.: US 2009/0273115 A1
(43) Pub. Date: Nov. 5, 2009

(54) METHOD OF PRODUCING FILM

(76) Inventors: Makoto Morikawa, Chiba (JP); Takahiro Kimino, Chiba (JP)

Correspondence Address: BIRCH STEWART KOLASCH & BIRCH, PO BOX 747, FALLS CHURCH, VA, 22040-0747, US

(21) Appl. No.: 12/293,535

(22) PCT Filed: Mar. 28, 2007
(86) PCT No.: PCT/JP2007/057514

§ 371 Date: Sep. 18, 2008

(30) Foreign Application Priority Data
Mar. 30, 2006 (JP) 2006-093747

(51) Int. Cl. B29C 47/00

(52) U.S. Cl. 264/177.18

(57) ABSTRACT

A method of producing a film, comprising the steps of melt-extruding a resin in the form of film from a T-die, powder-spraying an anti-blocking agent in an area-average spraying amount of 0.5 to 3 g/m² on the roll surface of a cooling roll, and nip roll the melt-extruded melted resin in the form of film on the roll surface of the cooling roll on which the anti-blocking agent has been powder-sprayed.

### TECHNICAL FIELD

The present invention relates to a method of producing a film.

### BACKGROUND ART

As films to be used for packaging of foods, medical goods, industrial products and the like, there are predominantly used films made of synthetic resins such as polyethylene resins, polypropylene resins and the like. In these films, blocking resistance and slipping property are required for enhancing workability in bag-making from a film and packaging of a packaged article.

As one of methods for producing a film made of a synthetic resin, a T-die film molding method is known in which a resin is melt-extruded in the form of film from a T-die, and the melt-extruded melted resin in the form of film is wound while cooling by allowing this to closely adhere to the role surface of a cooling roll. In this T-die film molding method, an anti-blocking agent is usually compounded in a resin for improving blocking resistance and slipping property, however, an effect of compounding of an anti-blocking agent is insufficient in some cases since a melted resin containing an anti-blocking agent compounded is allowed to closely adhere to the roll surface of a cooling roll.

Therefore, suggested as the method of improving blocking resistance and slipping property are dusting a film after molding with a fine powder such as starch and the like, compounding an anti-blocking agent in a low density polyethylene and performing molding of a T-die film so that the thickness of a layer composed of the low density polyethylene is smaller than the average particle diameter of the anti-blocking agent (JP-A No. 11-179778), compounding an anti-blocking agent of which surface has been hydrophobicized in a low density polyethylene and performing molding of a T-die film (JP-A No. 2002-225197), and the like.

In the method of dusting a film with a fine powder such as starch and the like, however, the fine powder adheres to the packaged article and poor seal of the film occurs in some cases due to leaving of the fine powder from the film. Further, the method of compounding an anti-blocking agent in a resin is not necessarily sufficiently satisfactory in blocking resistance and slipping property.

### DISCLOSURE OF THE INVENTION

Under such conditions, the present invention has an object of providing a method of producing a T-die film wherein the film is excellent in blocking resistance, slipping property and anti-leaving property of an anti-blocking agent.

That is, the present invention relates to a method of producing a film, comprising the steps of melt-extruding a resin in the form of film from a T-die, powder-spraying an anti-blocking agent in an area-average spraying amount of 0.5 to 3 g/m² on the roll surface of a cooling roll, and pressure-bonding the melt-extruded melted resin in the form of film on the roll surface of the cooling roll on which the anti-blocking agent has been powder-sprayed.

### MODES FOR CARRYING OUT THE INVENTION

The method of producing a film of the present invention has a step of melt-extruding a resin in the form of film from a T-die.

As the resin to be used in the present invention, those capable of producing a film by T-die processing such as polyolefin resins, polyamide resins, polyester resins, ethylene-vinyl alcohol copolymers, ionomer resins, polyvinyl chloride resins, polyvinylidene chloride resins, polyimide resins and the like are used.

The above-described polyolefin resin is a polymer containing 50 wt % or more of one or more monomer units based on an olefin having 2 to 10 carbon atoms such as ethylene, propylene, 1-butene, 1-hexene and the like, and includes polyethylene resins as a polymer containing 50 wt % or more of monomers units based on ethylene, polypropylene resins as a polymer containing 50 wt % or more of monomers units based on propylene, and the like.

Examples of the polyethylene resin include ethylene-α-olefin copolymers such as an ethylene homopolymers, ethylene-propylene copolymer, ethylene-1-butene copolymer, ethylene-1-hexene copolymer, ethylene-1-octene copolymer, ethylene-1-butene-1-hexene copolymer and the like; ethylene-vinyl ester copolymers such as an ethylene-vinyl acetate copolymer and the like; ethylene-unsaturated carboxylate copolymers such as an ethylene-methyl acrylate copolymer, ethylene-ethyl acrylate copolymer, ethylene-butyl acrylate copolymer, ethylene-methyl methacrylate copolymer, ethylene-ethyl methacrylate copolymer and the like; etc, and these are used singly or in combination of two or more. These polyethylene resins are produced by known methods.

Examples of the polypropylene resin include a propylene homopolymers, propylene-ethylene copolymer, propylene-1-butene copolymer, propylene-1-hexene copolymer, propylene-ethylene-1-butene copolymer, propylene-ethylene-1-hexene copolymer and the like, and these are used singly or in combination of two or more. These polypropylene resins are produced by known methods.

As the polyolefin resin, polyethylene resins are preferable, and the content of monomer units based on ethylene in the polyethylene resin is preferably 70 wt % or more, more preferably 80 wt % or more, further preferably 90 wt % or more with respect to the weight of the polyethylene resin being defined as 100 wt %.

Regarding the melt flow rate of the polyolefin resin, the melt flow rate measured under conditions of a load of 21.18 N and a temperature of 190° C. according to a method defined in JIS K7210-1995, in the case of the polyethylene resin, is preferably 1 to 100 g/10 minutes, more preferably 1.5 to 50 g/10 minutes, and the melt flow rate measured under conditions of a load of 21.18 N and a temperature of 230° C. according to a method defined in JIS K7210-1995, in the case of the polypropylene resin, is preferably 1 to 100 g/10 minutes, more preferably 1.5 to 50 g/10 minutes.

In the resin, if necessary, known additives, for example, an antioxidant, neutralizing agent, antistatic agent, anti-fogging agent, slipping agent and the like may be compounded, and other resins may be compounded.

In the case of melt-extrusion of the resin, it may be melt-extruded in the form of single layer, or may be melt-extruded in the form of multi layer such as co-extrusion and the like.

The temperature (temperature directly below a die) for melt-extrusion of the resin is, in the case of the polyolefin resin, preferably 150° C. or higher, more preferably 180° C. or higher from the standpoint of enhancement of anti-leaving property. It is preferably 340° C. or lower, more preferably 320° C. or lower from the standpoint of reduction of smoking in melt-extrusion and the order of a film and improvement in blocking resistance.

The method of producing a film of the present invention has a step of power-spraying an anti-blocking agent on the roll surface of a cooling roll.

Examples of the anti-blocking agent to be used in the present invention include inorganic anti-blocking agents such as natural silica, synthetic silica, zeolite, calcium carbonate, talc, glass powder and the like; organic anti-blocking agents such as a polymethacrylic acid resin, cross-linked polystyrene resin, cross-linked polymethyl methacrylate resin, cross-linked copolymer resin of methyl methacrylate with styrene, and the like. Further, blocking-preventing powders (for example, Nikkaryco manufactured by Nikka K.K.) for gravure film lamination and for printing, composed of corn starch and the like, can be used.

As the method of power-spraying an anti-blocking agent on the roll surface of a cooling roll, there are mentioned methods in which a powder of an anti-blocking agent is sprayed on the roll surface of a cooling roll by a powder spraying apparatus such as an electrostatic powder coating spray, blocking-preventing powder disseminating machine, dust generation apparatus for dust ability test, and the like.

The above-described electrostatic powder coating spray charges a powder to be sprayed, and sprays, with the aid of air and the like, the powder onto an earth-grounded body to be sprayed, and as the method of charging a powder, a charging method by corona, a charging method by friction, and the like are mentioned. As the electrostatic powder coating spray, commercially available sprays can be used, and as the electrostatic powder coating spray of corona charger type for effecting corona charging, for example, Opti Gun A (X) manufactured by Ransburg Industrial Finishing K.K., GX70000L manufactured by Nihon Parkerizing Co., Ltd., and the like are mentioned. As the electrostatic powder coating spray of friction charge type for effecting frictional charging, for example, Tribomatic 500 Hand Gun manufactured by Nordson K.K., and the like are mentioned. In powder spraying of an anti-blocking agent by an electrostatic powder coating spray, usually, the input air pressure is 0.6 to 1.0 MPa, and the spraying quantity per unit time of one spray is 1 to 50 g/minute. The output air quantity is usually 1 to 10 m³/hour. From the standpoint of spraying a powder selectively to a body to be sprayed, the output air quantity is preferably m³/hour or less, and from the standpoint of enhancing the blocking resistance and slipping property of a film, the output air quantity is preferably 2 m³/hour or more. The set voltage is usually 20 to 150 kV, and the set current is 40 to 150 μA. From the standpoint of carrying out spraying economically, it is preferable that the set voltage is 120 kV or less and the set voltage is 120 μA or less, and from the standpoint of spraying a powder selectively to a body to be sprayed, it is preferable that the set voltage is 40 kV or more and the set voltage is 60 μA or more. When the width for performing powder spray on the surface of a cooling roll is large, a plurality of electrostatic powder coating sprays can be arranged in the width direction and used simultaneously. Further, the sprays may be surrounded appropriately so as to prevent flying of a powder to peripheral areas.

In the above-described blocking-preventing powder disseminating machine, a powder storage vessel equipped with a roller and having an opening at lower part is mounted, the roller is rotated to allow a powder in the powder storage vessel to adhere to the roller and the adhered powder is allowed to detach from the roller by corona discharge and the like, thereby, the powder is sprayed on a body to be sprayed passing below the roller. As the blocking-preventing powder disseminating machine, those of commercially available can be used, and for example, Nikka Spray K—III manufactured by Nikka K.K., Nikka Spray K-V manufactured by Nikka K.K. having a flying-preventing function, and the like are mentioned. In powder-spraying of an anti-blocking agent by a blocking-preventing powder disseminating machine, the spraying quantity of a powder can be controlled by appropriately adjusting the roller speed of the disseminating machine. Usually, the roller speed is 0.2 to 20 rpm. Further, the disseminating machine may be surrounded appropriately so as to prevent flying of a powder to peripheral areas.

The above-described dust generation apparatus for dust ability test stirs a powder with air and the like by a mixer to give a desired powder concentration and rated quantity, and sprays the powder. As the dust generation apparatus for dust ability test, commercially available apparatuses can be used, and for example, Dust Departure DDP-1000 manufactured by Alpha K.K., and the like are mentioned. In powder-spraying of an anti-blocking agent by the dust generation apparatus for dust ability test, usually, the dust concentration is 1 to 100 g/m³ and the rated air quantity is 0.1 to 1.0 m³/minute. The apparatus may be surrounded appropriately or a recovery equipment may be provided so as to prevent flying of a powder to peripheral areas.

The area-average spraying amount of an anti-blocking agent onto the roll surface of a cooling roll is 0.5 g/m² or more. When the area-average spraying amount is too small, slipping property and blocking resistance may lower in some cases. Preferably, it is 1 g/m² or more. The area-average spraying amount is 3 g/m² or less. When the area-average spraying amount is too large, anti-leaving property may lower in some cases. Preferably, it is 2.5 g/m² or less. The area-average spraying amount is the amount of a powder sprayed on the roll surface, and is the value of part on which a dust has been sprayed per unit area. In the case of allowing a melted resin in the form of film continuously melt-extruded to be pressure-bonded continuously to the roll surface while rotating a cooling roll, to cool the resin, and winding the film, like a continuous molding method, the area-average spraying amount can be determined by the following formula.

C=g/(W×V)
C: area-average spraying amount (unit: g/m²)
g: spraying amount of a powder onto the roll surface per unit time (g/minute)
W: length along roll width direction of part of performing powder-spraying on the surface of cooling roll (unit: m).

V: circumferential speed of roll by rotation of cooling roll (unit: m/minute)

The method of producing a film of the present invention has a step of pressure-bonding a melt-extruded melted resin in the form of film on the roll surface of a cooling roll on which an anti-blocking agent has been powder-sprayed.

As the method of pressure-bonding a melt-extruded melted resin in the form of film on the roll surface of a cooling roll, a method by which a melted resin is pressed onto the roll surface of a cooling roll by a nip roll is mentioned. As the nip roll, rolls made of rubber such as silicon, neoprene and the like, rolls made of flexible metals (for example, Flex Roll manufactured by Sumitomo Heavy Industries Modern, Ltd.) and the like are used.

The pressure in pressure-bonding a melt-extruded melted resin in the form of film on the roll surface of a cooling roll is preferably 4.9 kN/m or more, and more preferably 15 kN/m or more, in terms of pressing roll linear pressure, from the standpoint of enhancing anti-leaving property. It is preferably 24.5 kN/m or less, and more preferably 24 kN/m or less from the standpoint of enhancing blocking resistance and slipping property.

In pressure-bonding a melt-extruded melted resin in the form of film on the roll surface of a cooling roll, a substrate film, for example, may be sent forth at the nip roll side of the melted resin, to arrange cooling roll/melted resin/substrate film/nip roll in this order, and the melted resin may be pressure-bonded to the roll surface of the cooling roll, by the nip roll via the substrate film, to obtain a multi-layered film having a layer made of the substrate.

As the substrate film, a resin film, paper, woven fabric, metal foil and the like are used. Examples of the resin to be used for the substrate include polyamide resins, polyester resins, ethylene-vinyl alcohol copolymers, polyvinyl alcohol, polypropylene resins, polyethylene resins, ionomer resins, cellophane, polyvinylidene chloride, polystyrene, polyvinyl chloride, polycarbonate, polymethyl methacrylate, polyurethane, fluorine resin, polyacrylonitrile, polybutene resins, polyimide resins, polyarylate resins, aetylcellulose and the like. The substrate film may also be a multi-layered film, or a laminated film of paper, woven fabric, metal foil or the like with a resin.

The temperature of the roll surface of a cooling roll is a temperature capable of cooling a melt-extruded melted resin in the form of film, and usually 5 to 80° C. This temperature is preferably 15° C. or higher from the standpoint of enhancing anti-leaving property, blocking resistance and slipping property, and preferably 40° C. or lower from the standpoint of enhancing the roll-leaving property of a film.

As the apparatus for melt-extruding a resin in the form of film from a T-die and pressure-bonding the melt-extruded melted resin in the form of film onto the roll surface of a cooling roll, known T-die film molding apparatuses equipped with an extruder with T-die, a cooling roll, a nip roll, a winder and the like can be used.

In the case of carrying out the present invention by a continuous molding method, that is, in the case of melt-extruding continuously a resin in the form of film from a T-die, and allowing the melted resin in the form of film continuously melt-extruded to be pressure-bonded continuously to the roll surface while rotating a cooling roll, to cool the resin, and winding the film, the line speed (rotation speed of a cooling roll (circumferential speed), winding speed) is usually 20 to 200 m/minute.

The arithmetic average roughness (Ra) of the surface on the cooling roll side of a film obtained by the production method of the present invention is preferably 0.2 μm or more in the case of having a substrate film and preferably 0.3 μm or more in the case of having no substrate film, from the standpoint of enhancing blocking resistance and slipping property, and is preferably 0.6 μm or less from the standpoint of enhancing anti-leaving property. The arithmetic average roughness (Ra) is a value represented by μm calculated by the following formula in which an X axis and Y axis are provided so as to cross mutually at a right angle on an average surface direction of a rough curved surface and a Z axis is provided in a longitudinal magnification direction (vertical to average surface), and then, a rough curved surface having a reference length in the X axis direction and a reference length in the Y axis direction is extracted from the rough curved surface, and the extracted rough curved surface is represented by z=f(x, y).

$${R}_{a} = \frac{1}{{L}_{x} {L}_{y}} {\int }_{0}^{{L}_{x}} {\int }_{0}^{{L}_{y}} \vert f ( x , y ) \vert d x d y$$

(Lx: reference length in X axis direction, Ly: reference length in Y axis direction).

The above-described arithmetic average roughness (Ra) is adjusted by appropriately altering the temperature for melt extrusion of a resin, the temperature of the roll surface of a cooling roll, the area-average spraying amount of an anti-blocking agent, the pressing roll linear pressure, the winding speed and the like.

The anti-blocking agent occupying ratio on the surface on the cooling roll side of a film obtained by the production method of the present invention is preferably 10% or more, more preferably 13% or more from the standpoint of enhancing blocking resistance and slipping property. It is preferably 30% or less, more preferably 27% or less from the standpoint of enhancing anti-leaving property. The anti-blocking agent occupying ratio is a proportion of the area occupied by an anti-blocking agent on the film surface, and obtained by observing shape images on the film surface by a microscope and the like, measuring the area of shape images on the film surface derived from an anti-blocking agent from the shape images, and calculating the proportion of the area of shape images on the film surface derived from an anti-blocking agent with respect to the total area (100%) of the shape images.

The film obtained by the production method of the present invention is excellent in blocking resistance, slipping property, and anti-leaving property of an anti-blocking agent. It is excellent also in transparency. Therefore, the film is used for various packaging materials, for example, food packaging materials, medical good packaging materials, industrial materials and the like.

### EXAMPLES

The present invention will be illustrated by examples and comparative examples below.

Measurements and evaluations of physical properties in examples were carried out by the following methods.

(1) Density (unit: kg/m³)

It was measured according to a method defined in A method of JIS K7112-1980. A sample was annealed as described in JIS K6760-1995.

(2) Melt flow rate (MFR, unit: g/10 minute)

It was measured according to a method defined in JIS K7210-1995, under conditions of a load of 21.18 N and a temperature of 190° C.

(3) slipping property (dynamic friction coefficient μk)

The dynamic friction coefficient between surfaces on the cooling roll side of a film was measured according to JIS K7125-1987. Smaller this value, more excellent the slipping property. A sample showing no slipping was described as “no slipping”.

(4) Blocking resistance (unit: g/100 cm²)

Two films sampled in the form of strip having a width of 10 cm×a length of 25 cm were overlapped so that the surface on the cooling roll side and the surface at the counter-cooling roll side came into contact, and pressure-bonded under conditions of a roll temperature of 60° C., a set pressure of 0.49 MPa and a processing speed of 0.5 m/minute using a test coater (manufactured by Yasui Seiki K.K.). A load was measured necessary for peeling the overlapped films (effective measurement surface: width 10 cm×length 10 cm) in the vertical direction (without applying shear force) at a peeling load speed of 20 g/minute using MacKenzie Blocking Tester (manufactured by Shimadzu Corp.) under a temperature of 23° C. and a humidity of 50%. Smaller this value, more excellent the blocking resistance.

(5) Anti-leaving property

A surface on the cooling roll side of a film was fractioned, and evaluated according to the following classification.
∘: Little attached of an anti-blocking agent to a finger
Δ: Slight attached of an anti-blocking agent to a finger
x: Attached of an anti-blocking agent to a finger
   (6) Arithmetic-average roughness (Ra, unit: μm)

### [Preparation of Measurement Sample]

A surface on the cooling roll side of a film was washed with acetone, then, cut into a size of about 4 cm×2 cm, then, this was pasted on a slide glass using a double stick tape so that the surface on the cooling roll side of a film was a measurement surface.

### [Measurement]

Height was measured using an ultra-depth shape measurement microscope (measurement part: VK-8510 manufactured by KEYENCE, controller part: VK-8550 manufactured by KEYENCE) under the following measurement conditions. In the measurement, it was confirmed that the measurement range (DISTANCE) in the height direction was larger sufficiently than the maximum height in the resultant height data.

### <Measurement Condition>

RUN MODE: color ultra-depth
VIEW MODE: light quantity data
Objective lens: CF IC EPI Plan 50×
   (manufactured by Nikon Corporation, magnification 50, numerical aperture 0.3, working distance 16.5 mm)
Optical zoom ×1
Digital zoom ×1
Area of measurement area: 66752 μm² (298 μm (X axis)×224 μm (Y axis))
Number of pixels in measurement region: 1024 pixel (X axis)×768 pixel (Y axis)
DISTANCE: 65 μm
PITCH: 0.02 μm

### [Calculation of Arithmetic-Average Roughness]

Ra was measured from the height data obtained in the Measurement, by a “surface roughness” measuring function of an analysis software (VK shape analysis application VK-H1W Ver.1.06 manufactured by KEYENCE) Prior to measurement, a treatment for smoothing the height data (size: 7×7, execution frequency: 1) was carried out.

(7) Anti-blocking agent occupying ratio (unit: %)

Shape images on the film surface were measured using an ultra-depth shape measurement microscope (measurement part: VK-8510 manufactured by KEYENCE, controller part: VK-8550 manufactured by KEYENCE) under the same conditions as for the above-described (6) Arithmetic-average roughness, and the proportion of the area of an anti-blocking agent occupying the film surface 66752 μm² (298 μm (X axis)×224 μm (Y axis)) was calculated. In the calculation, the area on the film surface formed of an anti-blocking agent was measured by selecting the outline of the anti-blocking agent in the shape images using “area (free line)” of “measurement analysis” function of an analysis software (VK shape analysis application VK-H1W Ver.1.06 manufactured by KEYENCE).

### Example 1

Using a T-die film molding apparatus [manufactured by Sumitomo Heavy Industries Modern, Ltd.], a polyethylene resin [Sumikathene CE4506 (MFR=7 g/10 minute, density=917 kg/m³) manufactured by Sumitomo Chemical Co., Ltd.,] was continuously melt-extruded in the form of film from a T-die (500 mm width), then, the melt-extruded melted resin in the form of film was continuously pressure-bonded by a nip roll (material: silicon rubber) to the roll surface of a cooling roll rotating at a circumferential speed of 30 m/minute, to cool the resin, and the resin was wound at 30 m/minute, to obtain a single layer film having a thickness of 30 μm. In the film processing, the temperature of the melted resin directly below the die was adjusted to 250° C., the air gap was adjusted to 150 mm, the cooling roll temperature was adjusted to 20° C., and the pressing roll linear pressure was adjusted to 19.6 kN/m. Further, in the film processing, a nozzle of an electrostatic powder coating spray [Opti Gun A (X) automatic powder gun GA01 manufactured by Ransburg Industrial Finishing K. K.,: with 40 mm nozzle] was set at a position of 800 mm in the vertical direction and 300 mm in the horizontal counter-T-die direction from the center of a cooling roll (diameter: 600 mm) as the starting point, and an inorganic anti-blocking agent [inorganic anti-blocking agent (synthetic aluminosilicate anti-blocking agent JC-50 (particle size=5.0 μm) manufactured by Mizusawa Kagaku K.K.)] was fed quantitatively to the spray using a trace amount powder feeder [Millifeeder Macro C-60G (with bridge breaker) manufactured by Alpha K.K.], and the spraying conditions were adjusted as described below by a gun controller [Optitronic powder gun controller CG03 manufactured by the same company] and powder-spraying was carried out from the nozzle of the spray toward the center of the cooling roll in a range of 330 mm width on the roll surface of the cooling roll at an area-average spraying amount of 2.0 g/m². The results of evaluation of the physical properties of the resulting single layer film are shown in Table 1.

<Spraying conditions>

| | | |
|---|---|---|
| Set voltage: | 100 | kV |
| Set current: | 100 | μA |
| Total air quantity: | 2.5 | m³/hour |

| | |
|---|---|
| Air proportion: | 90% |

### Comparative Example 1

The same operation as in Example 1 was carried out excepting that no anti-blocking agent was powder-sprayed. The results of evaluation of the physical properties of the resulting single layer film are shown in Table 1.

### Comparative Example 2

The same operation as in Example 1 was carried out excepting that no pressure-bonding was carried out. The results of evaluation of the physical properties of the resulting single layer film are shown in Table 1.

### Example 2

Using a T-die film molding apparatus [manufactured by Sumitomo Heavy Industries Modern, Ltd.], a polyethylene resin [Sumikathene L705 (MFR=7 g/10 minute, density=919 kg/m³) manufactured by Sumitomo Chemical Co., Ltd.,] was continuously melt-extruded in the form of film from a T-die (500 mm width). A biaxial-oriented polyamide film [Emblem ON manufactured by UNITIKA, thickness=16 μm] was sent forth to the nip roll side of the melted resin melt-extruded in the form of film, and the melted resin melt-extruded in the form of film was continuously pressure-bonded by a nip roll (material; silicon rubber) to the roll surface of a cooling roll rotating at a circumferential speed of 50 m/minute via the biaxial-oriented polyamide film, to cool the resin, and the resin was wound at 50 m/minute, to obtain a multi-layered film (polyethylene resin/polyamide) having a thickness of 35 μm. In the film processing, the temperature of the melted resin directly below the die was adjusted to 300° C., the air gap was adjusted to 150 mm, the cooling roll temperature was adjusted to 20° C., and the pressing roll linear pressure was adjusted to 19.6 kN/m. Further, in the film processing, a nozzle of an electrostatic powder coating spray [Opti Gun A (X) automatic powder gun GA01 manufactured by Ransburg Industrial Finishing K.K.,: with 40 mm nozzle] was set at a position of 800 mm in the vertical direction and 300 mm in the horizontal counter-T-die direction from the center of a cooling roll (diameter: 600 mm) as the starting point, and an inorganic anti-blocking agent [inorganic anti-blocking agent (synthetic aluminosilicate anti-blocking agent JC-50 (particle size=5.0 μm) manufactured by Mizusawa Kagaku K.K.)] was fed quantitatively to the spray using a trace amount powder feeder [Millifeeder Macro C-60G (with bridge breaker) manufactured by Alpha K.K.], and the spraying conditions were adjusted as described below by a gun controller [Optitronic powder gun controller CG03 manufactured by the same company] and powder-spraying was carried out from the nozzle of the spray toward the center of the cooling roll in a range of 330 mm width on the roll surface of the cooling roll at an area-average spraying amount of 1.2 g/m². The results of evaluation of the physical properties of the resulting multi-layered film are shown in Table 2.

<Spraying conditions>

| | | |
|---|---|---|
| Set voltage: | 100 | kV |
| Set current: | 100 | μA |
| Total air quantity: | 2.5 | m³/hour |

| | |
|---|---|
| Air proportion: | 90% |

### Example 3

The same operation as in Example 2 was carried out excepting that the area-average spraying amount of the anti-blocking agent was 2.0 g/m² and the circumferential speed of the cooling roll and the winding speed were 30 m/minute. The results of evaluation of the physical properties of the resulting multi-layered film are shown in Table 2.

### Comparative Example 3

The same operation as in Example 2 was carried out excepting that no anti-blocking agent was powder-sprayed and the circumferential speed of the cooling roll and the winding speed were 30 m/minute. The results of evaluation of the physical properties of the resulting multi-layered film are shown in Table 2.

### Comparative Example 4

The same operation as in Example 2 was carried out excepting that the area-average spraying amount of the anti-blocking agent was 4.0 g/m² and the circumferential speed of the cooling roll and the winding speed were 15 m/minute. The results of evaluation of the physical properties of the resulting multi-layered film are shown in Table 2.

### Comparative Example 5

The same operation as in Example 2 was carried out excepting that an organic anti-blocking agent (manufactured by Nippon Shokubai, spherical fine particle, Epostar MA1010 (polymethyl methacrylate cross-linked material, particle size=9.7 μm)) was used instead of the inorganic anti-blocking agent, the area-average spraying amount of the anti-blocking agent was 0.38 g/m² and the circumferential speed of the cooling roll and the winding speed were 80 m/minute. The results of evaluation of the physical properties of the resulting multi-layered film are shown in Table 2.

### Example 4

The same operation as in Example 2 was carried out excepting that other commercially available polyethylene resin [Sumikathene L211 (MFR=2 g/10 minute, density=924 kg/m³) manufactured by Sumitomo Chemical Co., Ltd.,] was used as the polyethylene resin, the circumferential speed of the cooling roll and the winding speed were 30 m/minute and the powder spraying amount of the anti-blocking agent was 2.0 g/m². The results of evaluation of the physical properties of the resulting multi-layered film are shown in Table 3.

### Example 5

The same operation as in Example 4 was carried out excepting that an organic anti-blocking agent (Epostar MA1010) was used as the anti-blocking agent, and the area-average spraying amount of the anti-blocking agent was 1.0 g/m². The results of evaluation of the physical properties of the resulting multi-layered film are shown in Table 3.

### Comparative Example 6

The same operation as in Example 4 was carried out excepting that no anti-blocking agent was powder-sprayed. The results of evaluation of the physical properties of the resulting multi-layered film are shown in Table 3.

### Example 6

Using a T-die film molding apparatus [manufactured by Sumitomo Heavy Industries Modern, Ltd.], a polyethylene resin [Sumikathene L705 (MFR=7 g/1 minute, density=919 kg/m³) manufactured by Sumitomo Chemical Co., Ltd.,] was continuously melt-extruded in the form of film from a T-die (500 mm width). A biaxial-oriented drawn polyamide film [Emblem ON manufactured by UNITIKA, thickness=16 μm] was sent forth to the nip roll side of the melted resin melt-extruded in the form of film, and the melted resin melt-extruded in the form of film was continuously pressure-bonded by a nip roll (material; silicon rubber) to the roll surface of a cooling roll rotating at a circumferential speed of 20 m/minute via the biaxial-oriented drawn polyamide film, to cool the resin, and the resin was wound at 20 m/minute, to obtain a multi-layered film (polyethylene resin/polyamide) having a thickness of 35 μm. In the film processing, the temperature of the melted resin directly below the die was adjusted to 300° C., the air gap was adjusted to 150 mm, the cooling roll temperature was adjusted to 20° C., and the pressing roll linear pressure was adjusted to 19.6 kN/m. Further, in the film processing, the lowest part of a wiper of a blocking preventing powder disseminating machine [Nikka Spray III manufactured by Nikka K.K.] was set at a position of 600 mm in the vertical direction and 100 mm in the horizontal counter-T-die direction from the center of a cooling roll (diameter: 600 mm) as the starting point, and an inorganic anti-blocking agent JC-50 was powder-sprayed toward the cooling roll at a roller revolution of the disseminating machine of 20 rpm in a range of 300 mm width on the roll surface of the cooling roll at an area-average spraying amount of 2.58 g/m². The results of evaluation of the physical properties of the resulting multi-layered film are shown in Table 4.

### Example 7

The same operation as in Example 6 was carried out excepting that the circumferential speed of the cooling roll and the winding speed were 80 m/minute and the powder spraying amount of the anti-blocking agent was 0.65 g/m². The results of evaluation of the physical properties of the resulting multi-layered film are shown in Table 4.

### Comparative Example 7

The same operation as in Example 6 was carried out excepting that the circumferential speed of the cooling roll and the winding speed were 80 m/minute, the roller revolution of the disseminating machine was 8.5 rpm and the powder spraying amount of the anti-blocking agent was 0.33 g/m². The results of evaluation of the physical properties of the resulting multi-layered film are shown in Table 4.

### Comparative Example 8

The same operation as in Example 6 was carried out excepting that the circumferential speed of the cooling roll and the winding speed were 80 m/minute, the roller revolution of the disseminating machine was 2.0 rpm and the powder spraying amount of the anti-blocking agent was 0.10 g/m². The results of evaluation of the physical properties of the resulting multi-layered film are shown in Table 4.

### Example 8

The same operation as in Example 6 was carried out excepting that an organic anti-blocking agent (Epostar MA1010) was used as the anti-blocking agent, the circumferential speed of the cooling roll and the winding speed were 80 m/minute, and the area-average spraying amount of the anti-blocking agent was 0.88 g/m². The results of evaluation of the physical properties of the resulting multi-layered film are shown in Table 5.

### Comparative Example 9

The same operation as in Example 6 was carried out excepting that an organic anti-blocking agent (Epostar MA1010) was used as the anti-blocking agent, and the area-average spraying amount of the anti-blocking agent was 3.51 g/m². The results of evaluation of the physical properties of the resulting multi-layered film are shown in Table 5.

### Comparative Example 10

The same operation as in Example 6 was carried out excepting that an organic anti-blocking agent (Epostar MA010) was used as the anti-blocking agent, the circumferential speed of the cooling roll and the winding speed were 80 m/minute, the roller revolution of the disseminating machine was 2.0 rpm, and the area-average spraying amount of the anti-blocking agent was 0.08 g/m². The results of evaluation of the physical properties of the resulting multi-layered film are shown in Table 5.

TABLE 1

| | | | Comparative | Comparative |
|---|---|---|---|---|
| | unit | Example 1 | Example 1 | Example 2 |
| processing | | | | |
| conditions | | | | |
| melt extrusion | ° C. | 250 | 250 | 250 |
| temperature | | | | |
| pressing roll | kN/m | 19.6 | 19.6 | — |
| linear pressure | | | | |
| area-average | g/m² | 2.0 | 0 | 2.0 |
| spraying amount | | | | |
| circumferential | m/ | 30 | 30 | 30 |
| speed of cooling | minute | | | |
| roll | | | | |
| physical | | | | |
| properties of | | | | |
| film | | | | |
| slipping | | 0.18 | no slipping | 0.18 |
| property | | | | |
| blocking | g/100 cm² | 0 | — | 0 |
| resistance | | | | |
| anti-leaving | | ∘ | ∘ | x |
| property | | | | |
| arithmetic | μm | 0.45 | 0.25 | — |
| surface | | | | |
| roughness | | | | |
| anti-blocking | % | 18.3 | 0 | — |
| agent occupying | | | | |
| ratio | | | | |

TABLE 2

| | | | | Comparative | Comparative | Comparative |
|---|---|---|---|---|---|---|
| | unit | Example 2 | Example 3 | Example 3 | Example 4 | Example 5 |
| processing | | | | | | |
| conditions | | | | | | |
| melt extrusion | ° C. | 300 | 300 | 300 | 300 | 300 |
| temperature | | | | | | |
| pressing roll | kN/m | 19.6 | 19.6 | 19.6 | 19.6 | 19.6 |
| linear pressure | | | | | | |
| area-average | g/m² | 1.2 | 2.0 | 0 | 4.0 | 0.38 |
| spraying amount | | | | | | |
| circumferential | m/ | 50 | 30 | 30 | 15 | 80 |
| speed of cooling | minute | | | | | |
| roll | | | | | | |
| physical | | | | | | |
| properties of | | | | | | |
| film | | | | | | |
| slipping | | 0.21 | 0.17 | no | 0.17 | no |
| property | | | | slipping | | slipping |
| blocking | g/100 cm² | 10.0 | 0 | 41.4 | 0 | 15.6 |
| resistance | | | | | | |
| anti-leaving | | ∘ | ∘ | ∘ | [symbol] | ∘ |
| property | | | | | | |
| arithmetic | μm | 0.28 | 0.35 | 0.13 | 0.69 | 0.15 |
| surface | | | | | | |
| roughness | | | | | | |
| anti-blocking | % | 16.9 | 24.4 | 0 | 31.6 | 9.2 |
| agent occupying | | | | | | |
| ratio | | | | | | |

TABLE 3

| | | | | Comparative |
|---|---|---|---|---|
| | unit | Example 4 | Example 5 | Example 6 |
| processing | | | | |
| conditions | | | | |
| melt extrusion | ° C. | 300 | 300 | 300 |
| temperature | | | | |
| pressing roll | kN/m | 19.6 | 19.6 | 19.6 |
| linear pressure | | | | |
| area-average | g/m² | 2.0 | 1.0 | 0 |
| spraying amount | | | | |
| circumferential | m/ | 30 | 30 | 30 |
| speed of cooling | minute | | | |
| roll | | | | |
| physical | | | | |
| properties of | | | | |
| film | | | | |
| slipping | | 0.22 | 0.63 | no slipping |
| property | | | | |
| blocking | g/100 cm² | 0 | 7.9 | 22.3 |
| resistance | | | | |
| anti-leaving | | ∘ | ∘ | ∘ |
| property | | | | |
| arithmetic | μm | 0.29 | 0.24 | 0.15 |
| surface | | | | |
| roughness | | | | |
| anti-blocking | % | 21.2 | 18.7 | 0 |
| agent occupying | | | | |
| ratio | | | | |

TABLE 4

| | | Ex- | Ex- | Comparative | Comparative |
|---|---|---|---|---|---|
| | unit | ample 6 | ample 7 | Example 7 | Example 8 |
| processing | | | | | |
| conditions | | | | | |
| melt extrusion | ° C. | 300 | 300 | 300 | 300 |
| temperature | | | | | |
| pressing roll | kN/m | 19.6 | 19.6 | 19.6 | 19.6 |
| linear pressure | | | | | |
| area-average | g/m² | 2.58 | 0.65 | 0.33 | 0.10 |
| spraying | | | | | |
| amount | | | | | |
| circumferential | m/ | 20 | 80 | 80 | 80 |
| speed of | minute | | | | |
| cooling roll | | | | | |
| physical | | | | | |
| properties of | | | | | |
| film | | | | | |
| slipping | | 0.18 | 0.30 | no | no |
| property | | | | slipping | slipping |
| blocking | g/100 | 0 | 27.8 | 28.5 | 29.2 |
| resistance | cm² | | | | |
| anti-leaving | | ∘ | ∘ | ∘ | ∘ |
| property | | | | | |
| arithmetic | μm | 0.55 | 0.22 | 0.11 | 0.08 |
| surface | | | | | |
| roughness | | | | | |
| anti-blocking | % | 23.9 | 19.0 | 6.5 | 3.1 |
| agent | | | | | |
| occupying ratio | | | | | |

TABLE 5

| | | | Comparative | Comparative |
|---|---|---|---|---|
| | unit | Example 8 | Example 9 | Example 10 |
| processing | | | | |
| conditions | | | | |
| melt extrusion | ° C. | 300 | 300 | 300 |
| temperature | | | | |
| pressing roll | kN/m | 19.6 | 19.6 | 19.6 |
| linear pressure | | | | |
| area-average | g/m² | 0.88 | 3.51 | 0.08 |
| spraying amount | | | | |
| circumferential | m/minute | 80 | 20 | 80 |
| speed of cooling | | | | |
| roll | | | | |
| physical | | | | |
| properties of | | | | |
| film | | | | |
| slipping | | 0.35 | 0.13 | no slipping |
| property | | | | |
| blocking | g/100 cm² | 29.6 | 8.6 | 28.0 |
| resistance | | | | |
| anti-leaving | | ∘ | x | ∘ |
| property | | | | |
| arithmetic | μm | 0.22 | 1.41 | 0.08 |
| surface | | | | |
| roughness | | | | |
| anti-blocking | % | 17.4 | 44.6 | 1.0 |
| agent occupying | | | | |
| ratio | | | | |

### INDUSTRIAL APPLICABILITY

According to the present invention, a method of producing a T-die film wherein the film is excellent in blocking resistance, slipping property and anti-leaving property of an anti-blocking agent can be provided.

1. A method of producing a film, comprising the steps of:
melt-extruding a resin in the form of film from a T-die,
powder-spraying an anti-blocking agent in an area-average spraying amount of 0.5 to 3 g/m² on the roll surface of a cooling roll, and
nip roll the melt-extruded melted resin in the form of film on the roll surface of the cooling roll on which the anti-blocking agent has been powder-sprayed.

2. The method of producing a film according to claim 1, wherein the resin is a polyolefin resin.

3. The method of producing a film according to claim 1 or 2, wherein the resin melt-extruding temperature is 150 to 340° C., and the melt-extruded melted resin in the form of film is pressure-bonded to the roll surface with a pressing roll linear pressure of 4.9 to 24.5 kN/m.

4. The method of producing a film according to claim 1, wherein the anti-blocking agent is powder-sprayed on the roll surface by an electrostatic powder coating spray.

5. The method of producing a film according to claim 1, wherein the anti-blocking agent is powder-sprayed on the roll surface by a blocking-preventing powder disseminating machine.
